(19) United States
(12) Patent Application Publication
(10) Pub. No.: US 2010/0184443 A1
(43) Pub. Date: Jul. 22, 2010

(54) EXPLICIT LAYER TWO SIGNALING FOR DISCONTINUOUS RECEPTION

(75) Inventor: Shugong Xu, Osaka (JP)

Correspondence Address: MICHAEL BLAINE BROOKS, P.C., P.O. BOX 1630, SIMI VALLEY, CA, 93062-1630, US

(73) Assignee: SHARP KABUSHIKI KAISHA, Osaka (JP)

(21) Appl. No.: 12/530,778

(22) PCT Filed: Mar. 11, 2008
(86) PCT No.: PCT/JP2008/054841

§ 371 Date: Sep. 10, 2009

Related U.S. Application Data
(63) Continuation of application No. 11/684,934, filed on Mar. 12, 2007.

(51) Int. Cl. H04W 72/00

(52) U.S. Cl. 455/450

(57) ABSTRACT

The embodiments of the present invention provide for methods, devices, and systems adapted to enable an eNodeB to instruct a user equipment (UE) to adjust its current discontinuous reception (DRX) parameter by Layer 2 signaling, in particular, via Layer 2 protocol data units.

Priority is claimed on U.S. patent application Ser. No. 11/684,934, filed Mar. 12, 2007, the content of which is incorporated herein by reference.

### TECHNICAL FIELD

The present invention relates to discontinuous reception (DRX), particularly to DRX in Evolved Universal Terrestrial Radio Access Network (E-UTRAN) and Long Term Evolution (LTE).

### BACKGROUND ART

The 3rd Generation Partnership Project, also referred to as “3GPP,” is a collaboration agreement that aims to define globally applicable Technical Specifications and Technical Reports for 3rd Generation Systems. 3GPP Long Term Evolution (LTE) is the name given to a project to improve the Universal Mobile Telecommunications System (UMTS) mobile phone or device standard to cope with future requirements. Although termed 3GPP, the 3GPP may define specification for the next generation mobile networks, systems, and devices. In one aspect, UMTS has been modified to provide support and specification for the Evolved Universal Terrestrial Radio Access (E-UTRA) and Evolved Universal Terrestrial Radio Access Network (E-UTRAN). A technical specification for the E-UTRA and E-UTRAN may be found in the 3GPP website, www.3gpp.org, e.g., in the TS 36.300 document.

Mobile devices are common nowadays. Such devices typically require power, such as from a battery, to run. Considering that the typical battery life is limited, ways of efficiently utilizing this limited resource, as well as providing good user experience are desirable. In defining the specification, one of the goals of E-UTRA and E-UTRAN is to provide power-saving possibilities on the side of the user device, whether such device is in the idle or active mode. In one aspect, power-saving means are provided by discontinuous reception (DRX) schemes.

The E-UTRAN and E-UTRA specifications recommend that a client device or user equipment (UE) in E-UTRAN active mode supports the following: (1) fast throughput between the network and the UE, (2) good power-saving schemes on the UE side, and (3) the synchronization of the network and UE DRX intervals. The fast throughput may be supported, for example, by providing for short DRX periods, whenever possible. Power saving schemes may be also be supported by applying long DRX periods, whenever possible. The specifications thus recommend flexible DRX periods. Furthermore, in supporting this flexibility, the specifications recommend a DRX scheme or mechanism that ensures that the setting and/or changing of DRX parameters is performed in such a manner that enables network and UE DRX synchronization to be maintained at all times. Ways of addressing the E-UTRAN and E-UTRA specifications and goals are thus highly desirable.

### DISCLOSURE OF INVENTION

In one aspect, a method of discontinuous reception (DRX) management by an eNodeB is provided. The method includes the steps of receiving via a Layer 3 signaling, by a user equipment (UE), a set of one or more DRX parameters; determining by said eNodeB a current DRX indicator for said UE; transmitting by said eNodeB said current DRX indicator via a Layer 2 protocol data unit; receiving by said UE said Layer 2 protocol data unit (PDU); associating said current DRX indicator to a DRX parameter from said set of one or more DRX parameters; and applying by said UE said associated DRX parameter for discontinuous reception.

In another aspect, a system, which includes an eNodeB and a user equipment, is provided. The eNodeB includes a discontinuous reception (DRX) controller module and a communication interface module. The DRX controller module is adapted to: determine a set of one or more DRX parameters; transmit said set of DRX parameters to a user equipment (UE) via Layer 3 signaling; determine a current DRX indicator for said UE; and transmit said current DRX indicator to said UE via a Layer 2 protocol data unit (PDU). The communication interface module, on the other hand, is adapted to enable communication between said UE and said eNodeB. The UE includes a DRX execution module and a communication interface module. The DRX execution module is adapted to: receive said set of discontinuous reception (DRX) parameters transmitted by said eNodeB; receive said current DRX indicator via said Layer 2 PDU; associate said current DRX indicator to a DRX parameter from said set of DRX parameters; and apply said associated DRX parameter for discontinuous reception. The communication interface module is adapted to enable communication between said UE and said eNodeB.

In another aspect, a user equipment device, adapted to communicate with an eNodeB, is provided. The user equipment device includes a discontinuous reception (DRX) execution module adapted to: receive a set of DRX parameters transmitted by said eNodeB; receive a current DRX indicator via said Layer 2 PDU; associate said current DRX indicator to a DRX parameter from said set of DRX parameters; and apply said associated DRX parameter for discontinuous reception. The user equipment device also includes a communication interface module adapted to enable communication between said device and said eNodeB.

### BRIEF DESCRIPTION OF THE DRAWINGS

The present invention is illustrated by way of example and not limitation in the figures of the accompanying drawings, and in which:

FIG. 1 is a high-level block diagram of an exemplary radio communication system, according to an embodiment of the invention;

FIG. 2 is a high-level block diagram of exemplary control protocol stacks of a station, such as an eNodeB, and a user equipment (UE), according to an embodiment of the invention;

FIG. 3 is a high-level block diagram of exemplary signals or messages that may be transmitted between an eNodeB and one or more UEs, according to an embodiment of the invention;

FIG. 4 is a diagram of exemplary discontinuous reception (DRX) fields and their associated definitions, according to embodiments of the invention;

FIG. 5 is another diagram of other exemplary DRX fields and their associated definitions, according to embodiments of the invention;

FIG. 6 is a block diagram of an exemplary eNodeB station, according to an embodiment of the invention; and

FIG. 7 is a block diagram of an exemplary UE device, according to an embodiment of the invention.

### BEST MODE FOR CARRYING OUT THE INVENTION

The embodiments of the present invention relate to discontinuous reception (DRX), particularly those applied within the Evolved Universal Terrestrial Radio Access (E-UTRA) and Evolved Universal Terrestrial Radio Access Network (E-UTRAN). Although described in relation to E-UTRA and E-UTRAN, the embodiments of the present invention may apply to other networks, wired or wireless, and to other specifications or standards, including those that may later be developed.

E-UTRA and E-UTRAN provide for packet-based systems adapted to support both real-time and conversational class traffic. This packet-centric system may be characterized by discontinuous and bursty data. In some embodiments of the invention, DRX is employed, so as to take advantage of the characteristics of data being transferred within the network and to conserve the limited battery life of user equipments. The embodiments of the present invention provide for systems, devices, and methods adapted to have a base station—eNodeB in E-UTRA and E-UTRAN—to instruct a UE to adjust its current DRX parameter, particularly, its DRX period. In particular, the embodiments of the present invention may apply to 3GPP LTE. One of ordinary skill in the art having the benefit of this disclosure, however, will appreciate that the devices, systems, and procedures described herein, for controlling power via DRX signaling, may also be applied to other applications.

Generally, the DRX parameter to be applied by a user equipment (UE) may be transmitted via in-band signaling, which is via Layer 2 data units or protocol data units. The indication of which DRX parameter to be applied may be contained as part of the header format, be part of the payload, and/or both. The DRX processes and features described herein are designed to augment, and not replace, existing DRX processes, e.g., as defined by 3GPP, which include E-UTRA and E-UTRAN.

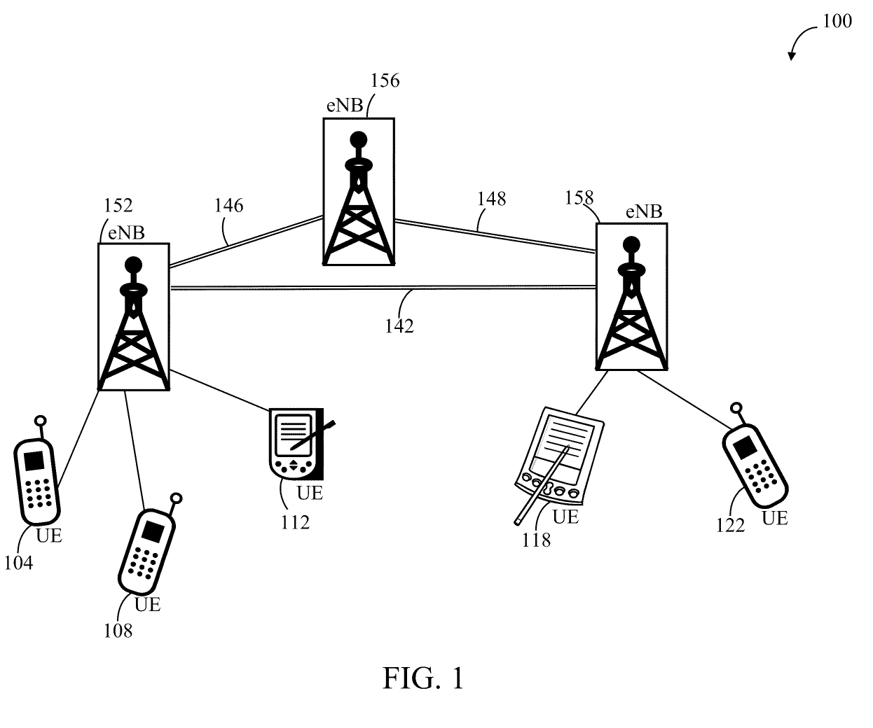

FIG. 1 is an exemplary diagram of a mobile and/or radio communication system 100, according to an embodiment of the invention. This exemplary system 100 is an exemplary E-UTRAN. An E-UTRAN may consist of one or more base stations, typically referred to as eNodeBs or eNBs 152, 156, 158, providing the E-UTRA user-plane and control-plane protocol terminations towards the UE. An eNodeB is a unit adapted to transmit to and receive data from cells. In general, an eNodeB handles the actual communication across the radio interface, covering a specific geographical area, also referred to as a cell. Depending on sectoring, one or more cells may be served by an eNodeB, and accordingly the eNodeB may support one or more mobile user equipments (UEs) depending on where the UEs are located.

An eNodeB 152, 156, 158 may perform several functions, which may include but are not limited to, radio resource management, radio bearer control, radio admission control, connection mobility control, dynamic resource allocation or scheduling, and/or scheduling and transmission of paging messages and broadcast information. An eNodeB 152, 156, 158 is also adapted to determine and/or define the set of DRX parameters, including the initial set, for each UE managed by that eNodeB, as well as transmit such DRX parameters.

In this exemplary system 100, there are three eNodeBs 152, 156, 158. The first eNodeB 152 manages, including providing service and connections to, three UEs 104, 108, 112. Another eNodeB 158 manages two UEs 118, 122. Examples of UEs include mobile phones, personal digital assistants (PDAs), computers, and other devices that are adapted to communicate with this mobile communication system.

The eNBs 152, 156, 158 of the present invention may communicate 142, 146, 148 with each other, via an X2 interface, as defined within 3GPP. Each eNodeB may also communicate with a Mobile Management Entity (MME) and/or a System Architecture Evolution (SAE) Gateway, not shown. The communication between an MME/SAE Gateway and an eNodeB is via an S1 interface, as defined within the Evolved Packet Core specification within 3GPP.

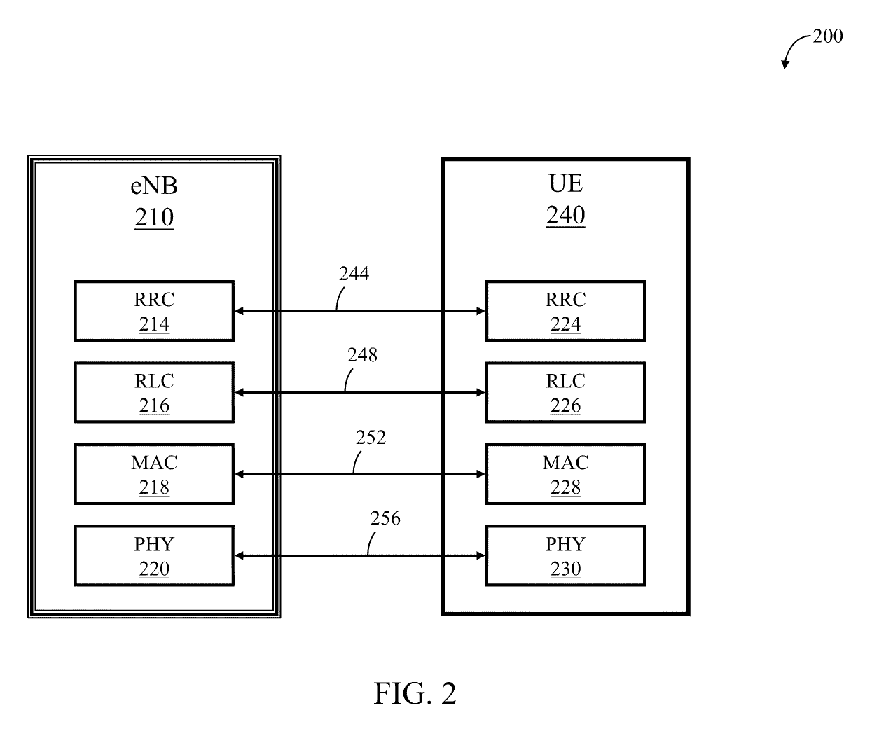

FIG. 2 is an exemplary diagram 200 of a portion of the protocol stack for the control plane of an exemplary UE 240 and an exemplary eNodeB 210. The exemplary protocol stacks provide a radio interface architecture between an eNodeB 210 and a UE 240. The control plane in general includes a Layer 1 stack consisting of a physical PHY layer 220, 230, a Layer 2 stack consisting of a medium access control (MAC) 218, 228 layer, and a Radio Link Control (RLC) layer 216, 226, and a Layer 3 stack consisting of a Radio Resource Control (RRC) layer 214, 224. There is another layer referred to as Packet Data Convergence Protocol (PDCP) layer in E-UTRA and E-UTRAN, not shown. The inclusion of the PDCP layer in the control plane is still being decided by 3GPP. The PDCP layer is likely to be deemed a Layer 2 protocol stack.

The RRC layer 214, 224 is generally a Layer 3 radio interface adapted to provide information transfer service to the non-access stratum. The RRC layer of the present invention also transfers DRX parameters from the eNodeB 210 to the UE 240, as well as provide RRC connection management. The DRX period being applied by a UE is typically associated with a discontinuous transmission (DTX) period at the eNodeB side to ensure that data are transmitted by the eNodeB and received by the UE at the appropriate time periods.

The RLC 216, 226 is a Layer 2 radio interface adapted to provide transparent, unacknowledged, and acknowledged data transfer service. While the MAC layer 218, 228 is a radio interface layer providing unacknowledged data transfer service on the logical channels and access to transport channels. The MAC layer 218, 228 is also typically adapted to provide mappings between logical channels and transport channels.

The PHY layer 220, 230 generally provides information transfer services to MAC 218, 228 and other higher layers 216, 214, 226, 224. Typically the PHY layer transport services are described by their manner of transport. Furthermore, the PHY layer 220, 230 is typically adapted to provide multiple control channels. The UE 240 is adapted to monitor this set of control channels. Furthermore, as shown, each layer communicates with its compatible layer 244, 248, 252, 256. The specifications, including the conventional functions of each layer, may be found in the 3GPP website, www.3gpp.org.

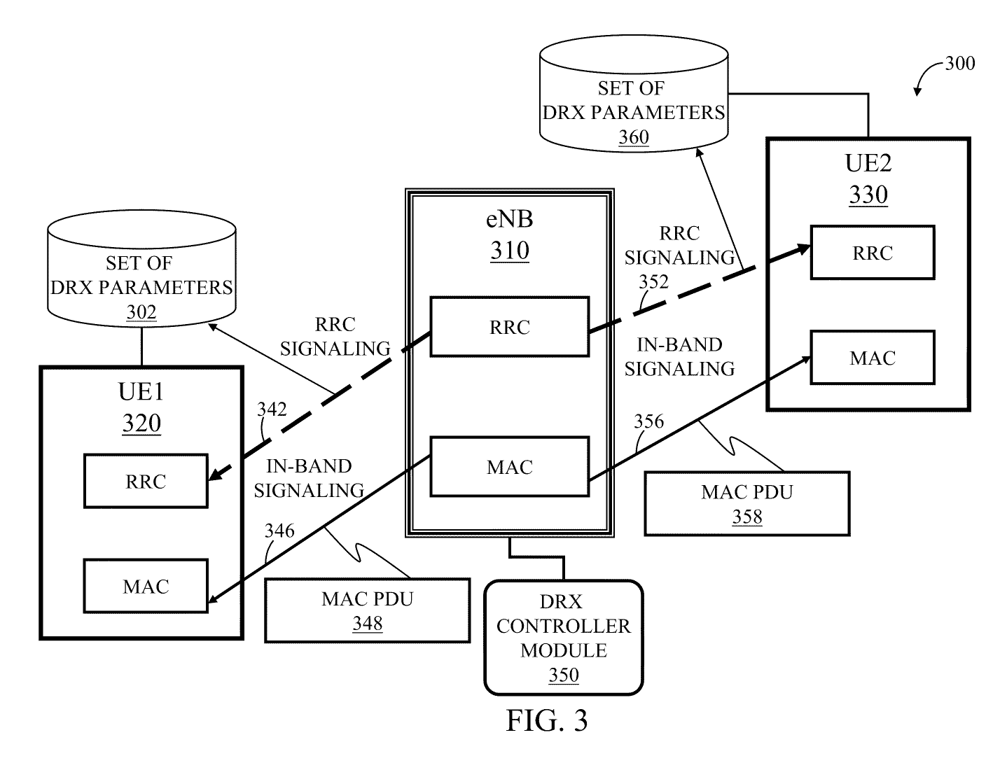

FIG. 3 is a block diagram 300 showing exemplary manners in which a UE 320, 330 may receive DRX parameters from the eNodeB 310, according to an embodiment of the invention. In this exemplary embodiment, the eNodeB 310 manages two UEs 320, 330. The DRX controller module 350 is a functional block diagram of the eNodeB 310 that typically determines and defines the set of DRX parameters to be sent to the UE, as well as which DRX parameter, particularly DRX period, is to be applied by the UE. The determination of the set of parameters particular to a UE and the determination of which DRX parameter to instruct the UE to apply may be based on the 3GPP specification or based on other algorithms. Such determination by the eNodeB 310 may be, for example, based on the eNodeB downlink buffer status, network traffic pattern, UE activity level, radio bearer quality of service (QOS) requirements, network traffic volume, neighbor cell measurements information, and/or other conditions. Considering that the eNodeB hosts or performs the scheduling function, such determination may provide good throughput, as well as a good battery-saving performance scheme. The DRX controller module 350 may be embodied as a set of program instructions—e.g., software, hardware—e.g., chips and circuits, or both—e.g., firmware.

The E-UTRA and E-UTRAN support control signaling via L1/L2 control channel, via MAC control protocol data unit (PDU), and RRC control signaling. The embodiments of the invention provide in-band signaling 346, 356 via Layer 2 control protocol stack data units, such as via MAC PDUs, RLC data units, or possible PDCP data units, and not via L1/L2 control channel signaling. In general, however, only one type of Layer 2 protocol stack PDU is applied to perform the in-band signaling features described herein, per communication system 100. For example, if MAC PDUs are used for Layer 2 in-band signaling in System A, System A only uses MAC PDUs, i.e., it may not augment Layer 2 in-band signaling of the present invention to adjust DRX parameters with RLC PDUs in System A. Thus, each system 100 may use only one type of Layer 2 protocol stack PDU for in-band signaling. An unrelated communication system B, however, may use another type of Layer 2 protocol stack PDU, e.g., RLC PDU, for in-band signaling, but similarly, System B may only use that type of Layer 2 protocol stack PDU. A system, however, may use some or all types of Layer 2 PDUs in its system for various reasons and functions, so long as the system uses only one Layer 2 protocol stack type for in-band signaling of the present invention.

L1/L2 signaling, in some embodiments, may be considered as a most likely error-prone way of signaling. L1/L2 signaling may also be considered to take more resources than in-band signaling using Layer 2 data units. Although RRC control signaling 342, 352 and typically any Layer 3 signaling may be considered more reliable than in-band signaling via Layer 2 data units, RRC signaling however, is typically slower than signaling via Layer 2 data units. Furthermore, the reliability of signaling via Layer 2 data units may be significantly improved after hybrid automatic repeat request (HARD), as compared to L1/L2 signaling. The embodiments of the present invention augment RRC signaling of DRX parameters with in-band signaling of DRX parameters. Layer 3 signaling, in general, relates to the communication between a Layer 3 protocol stack of the eNodeB 210 to a corresponding compatible Layer 3 protocol stack of the UE 240. As mentioned, Layer 3 signaling although more reliable is typically slower than Layer 2 signaling.

In some embodiments, Layer 3 RRC signaling, from the eNodeB 310 to the UE 320, 330, provides an initial set of DRX parameters to configure the UE, for example, upon connection to the network. This initial set of DRX parameters may be replaced by the eNodeB 310 via another RRC signaling 342, 352. RRC signaling may also provide a current RRC DRX parameter, i.e., the DRX parameter to be applied by the UE, which may have been signaled by the RRC when a radio bearer was setup or based on a last RRC update, for example. This current RRC DRX parameter may be an initial default value. The DRX parameter to be applied may be transmitted by the eNodeB via in-band signaling and/or RRC signaling. The set of DRX parameters received via RRC signaling thus provides a set of DRX parameters from which the UE may be instructed to select the DRX parameter to apply by the UE. RRC signaling may also be applied to explicitly change the current DRX parameter being applied, which may have been set or configured via a previous RRC signaling or in-band signaling. The set of DRX parameters may be changed by the eNodeB based on conditions and/or triggering events, e.g., new radio bearer connections, decline in QOS of one or more radio bearers, network traffic, and the like.

In general, each radio bearer for a UE has its own QOS requirement, e.g., Voice over Internet Protocol (VoIP), File Transfer Protocol (FTP), and instant messaging each have their own QOS requirements. Although a UE may be serviced by multiple radio bearers, the embodiments of the present invention provide for one set of DRX parameters and/or a DRX parameter to be applied by the UE, per UE and not per radio bearer. Described in another way, DRX parameters are typically defined per UE and not per radio bearer. For example, if a UE is receiving three radio bearer services, e.g., VoIP, FTP, and instant messaging, the UE is configured with one set of DRX parameters, rather than three sets. Furthermore, the UE is instructed to apply one DRX parameter, rather than one DRX parameter per radio bearer.

In general, a DRX parameter may include or relate to a number of DRX information, including when a UE may go to sleep and for how long. A DRX cycle length, for example, is generally the time distance between the start positions of two consecutive active periods. An active period is the period during when a UE's transmitter and/or receiver is turned on, while a sleep period is the period during which a UE's transmitter and/or receiver is turned off, thereby saving power. Described in another way, the set of DRX parameters enables a UE to go to sleep and just be periodically awake or active to receive incoming data.

As mentioned, an adjustment or change to the DRX parameter being applied by a UE may be indicated or instructed via in-band signaling 346, 356. Such DRX adjustment or change may be applied immediately after receipt of that in-band signaling, based on other conditions instructed by the eNodeB—e.g., delay parameters, or based on conditions defined by 3GPP. The RRC signaling of DRX parameters may be applied similarly to in-band signaling.

Considering that in-band signaling 346, 356 is at Layer 2, in-band signaling thus is adapted to provide DRX signaling that is typically transmitted and received faster than RRC signaling, thereby providing fast adjustments of the DRX parameter, particularly its period or duration. In some embodiments, in-band signaling 346, 356 may indicate the DRX parameter to apply from the set of DRX parameters configured in the UE. In-band signaling 346, 356 may also provide the actual value of the DRX parameter to be applied by the UE. Furthermore, in-band signaling may also indicate to the UE to apply the next longer DRX period, the next smaller DRX period, no DRX period at all—meaning continuous reception, or the same DRX period currently being applied. Thus, in-band signaling is adapted to lengthen or shorten the applied DRX period, to make no change to the currently applied DRX parameter, and to change the DRX mode to a continuous reception mode or vice versa. In-band signaling is typically performed via available channels being utilized by Layer 2 protocol stacks, without allocating additional channel(s) for such signaling.

The set of DRX parameters provided by RRC signaling may include one or more DRX parameters, e.g., one or more parameters related to varying length of DRX periods. As mentioned, a DRX parameter may include or indicate a number of information, such as a DRX duration, when to start a DRX period, and other information. DRX parameters related to periods, for example, may be based on fractions of time increased by a factor of two. Once the set of DRX parameters is received by the UE, the UE may store these one or more DRX parameters in an appropriate data store, such as in a memory chip.

The eNodeB 310 of FIG. 3 is shown transmitting, via RRC signaling 342, one set of DRX parameters 302 to UE1 320. This set of DRX parameters may be an initial set or an updated set that was signaled by eNodeB 310 in response to a new bearer connection for that UE1. RRC signaling 342 may also include the DRX parameter to be applied by the UE1 320 as instructed by the eNodeB 310. The set of DRX parameters 302, the DRX parameter to be applied and/or other DRX information may be configured in the UE1, by storing such information in a UE1 data store.

For illustrative purposes, let us assume that eNodeB 310, at a later time, has determined that the DRX parameter being applied by UE1 320 has to be adjusted. Such adjustment instruction may be transmitted by the eNodeB 310, via in-band signaling 346, for example, via a MAC PDU 348 or any other Layer 2 data unit. Similarly, the eNodeB 310 may adjust the DRX parameter being applied by UE2 330, by in-band signaling 356, e.g., via a MAC PDU 358. The MAC PDU 358 may indicate the DRX parameter to be applied from the set of DRX parameters 360 configured in UE2 330.

In some embodiments of the invention, in-band signaling is carried by Layer 2 PDU as a header, e.g., as MAC PDU header, as payload, e.g., MAC PDU payload, or as both header and payload. In some embodiments, the exemplary system may be designed such that in-band signaling is carried, for example, by the MAC PDU every time a MAC PDU is transmitted from the eNodeB 310 to the UE 320, 330. In other embodiments, the system may be designed such that in-band signaling is carried only, e.g., by the MAC PDU, only when an adjustment has to be performed at the UE side or based on other conditions, e.g., periodically.

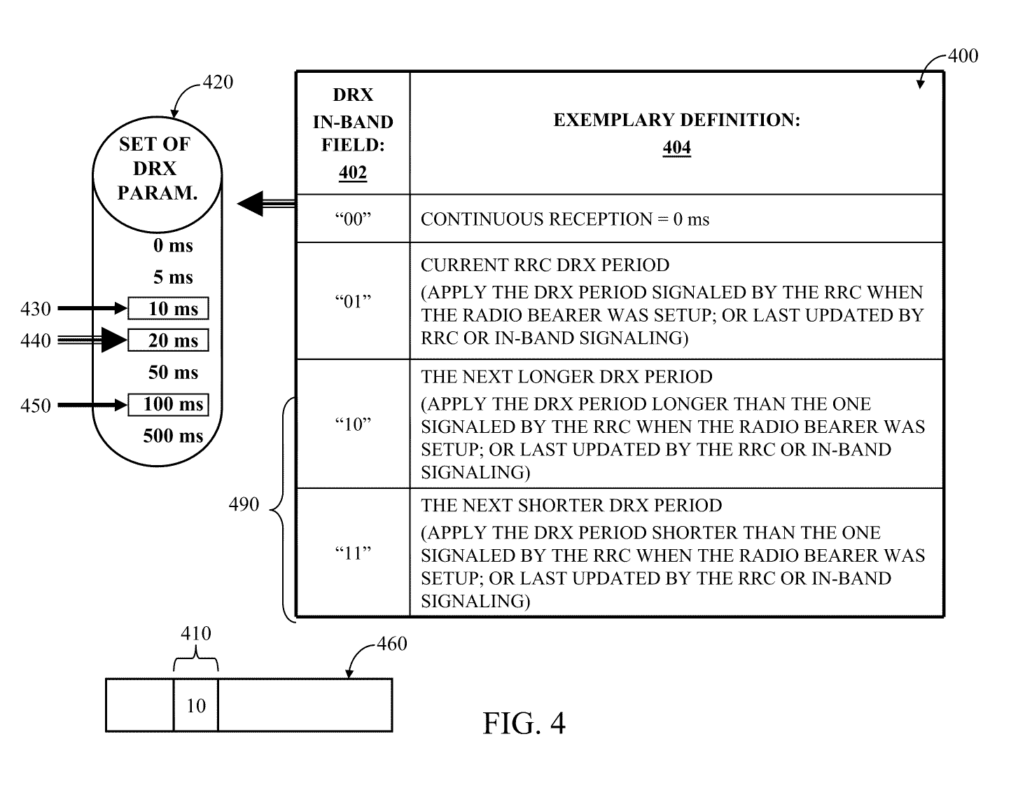

FIG. 4 is a diagram 400 of an exemplary field 402 (which is also referred to as “DRX indicator”) that may be placed in a MAC PDU, either in the header area/section, payload area/section, or both, so as to perform the in-band signaling process of the present invention. As mentioned above, such in-band signaling may be performed via other Layer 2 data units, rather than MAC PDUs.

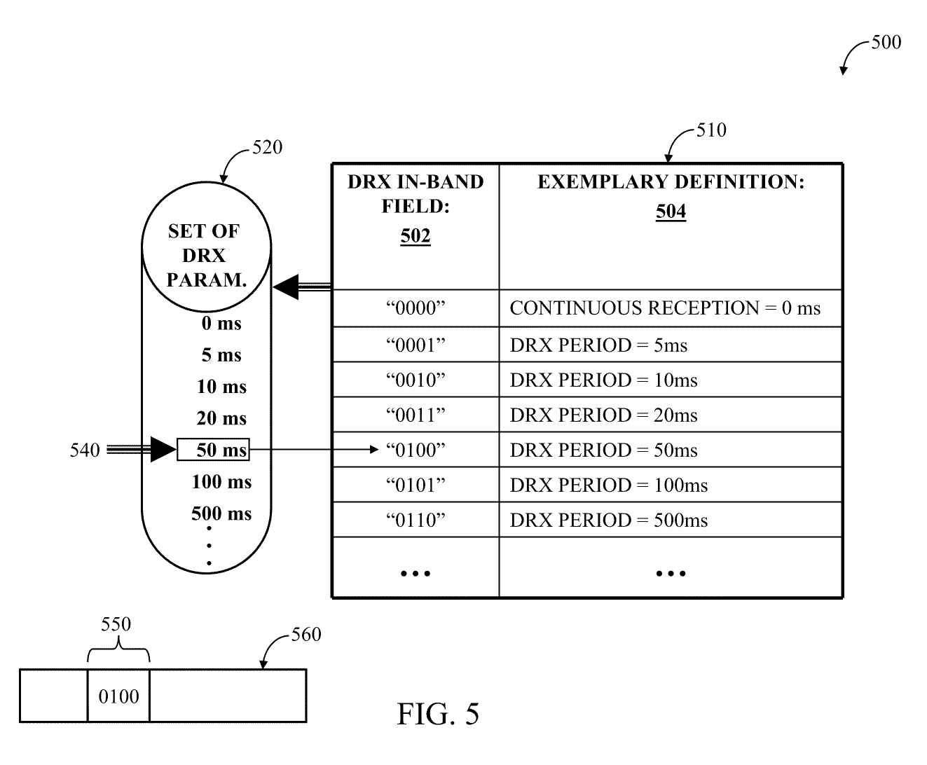

The exemplary DRX in-band field (DRX indicator) 402 of the present invention provides for two bits, which may indicate up to four values. In this example, the set of DRX parameters being adjusted is related to the DRX period or duration. In other embodiments, the set of DRX parameters being adjusted may be related to when the DRX period is to start. In other embodiments, the set of DRX parameters may be related to a combination of information, such as to the DRX period and to when such DRX period is to start. The use of the DRX period in the set of DRX parameters, in FIGS. 4 and 5, is for exemplification purposes. The exemplified embodiments of the present invention may be modified, such that the set of DRX parameters to be adjusted by Layer 2 signaling of the present invention is related to when a DRX period is to start. If the set of DRX parameters is related to when a DRX period is to start, the exemplary definitions, associated with the in-band fields (DRX indicator) 402, may also have to be modified. Furthermore, the use of two bits is for exemplification purposes.

In this exemplary embodiment, each value of the bits is associated with an exemplary definition 404, which may be applied to adjust or replace the current DRX period. The set of DRX parameters 420 is shown related to DRX periods. For example, “00” in the in-band field (DRX indicator) 402 indicates the UE is to apply continuous reception, while “01” indicates that the UE apply the last DRX parameter signaled via RRC signaling, “10” indicates that the UE apply the next longer DRX parameter, and “11” indicates that the UE apply the next shorter DRX parameter.

To illustrate, an exemplary UE is configured with a set of DRX parameters 420, which may have been received from an eNodeB via RRC signaling. The UE, in this example, currently applies a current DRX parameter period of 10 ms 430. Let us further assume that at a previous RRC signaling, the UE is instructed to use 100 ms as a current RRC DRX period 450. The current DRX parameter of 10 ms 430 is due to an in-band signaling previously received by the UE after the RRC signaling. A new in-band signaling 460, as a MAC PDU, is received by the UE and which contains an in-band field 410, which may be in the header, payload, or both areas, with a value of “10.” The receipt of this in-band signaling by the UE thus instructs the UE to apply the next longer DRX period, which in this case is 20 ms 440. After receipt of this in-band signaling 460, the UE thus adjusts its current DRX parameter and applies this new 20 ms DRX period 440.

In some other embodiments, the in-band signaling process only provides for one bit, and thus may indicate two values. In this example, the in-band signaling may instruct the UE to switch to a next longer DRX period—e.g., as a “0” bit value, or to the next shorter DRX period—e.g., with a “1” bit value 490. In some embodiments, more than two bits may also be used.

FIG. 5 is another diagram 500 of another embodiment of the in-band signaling of the present invention, but where the exemplary DRX in-band field (DRX indicator) 502 is used to indicate or represent possible DRX values 504, particularly DRX periods. In this example, the in-band field (DRX indicator) 502 contains 4 bits, from “0000” to “1111,” indicating actual DRX periods. The association of DRX in-band field (DRX indicator) 502 and its associated exemplary definition 504 is exemplified in the table 510. For illustrative purposes, let us assume that the UE is configured with a set of DRX parameters with 16 possible DRX periods 520. The UE receives an RLC PDU 560, which contains a “0100” 550 for its DRX in-band field (DRX indicator) 502. After receipt of this in-band signaling by the UE, the UE adjusts its current DRX period to 50 ms 540, considering that “0100” indicates 50 ms.

In other embodiments, the UE may not have stored the exemplary set of DRX parameters 520. The UE, however, may be coded or configured, e.g., via a set of program instructions or software applications, to know that, for example, “0100” is associated with 50 ms, and “0101” is associated with 100 ms.

Although the exemplary embodiments in FIG. 4 and FIG. 5 illustrate exemplary in-band fields and their exemplary definitions, i.e., bits definition, other bits definition may be varied and yet still be in the scope of the present invention. For example, the number of bits and/or definitions may be changed and yet still be in the scope of the present invention. Furthermore, the set of DRX parameters may be related to a different DRX information, other than the DRX period.

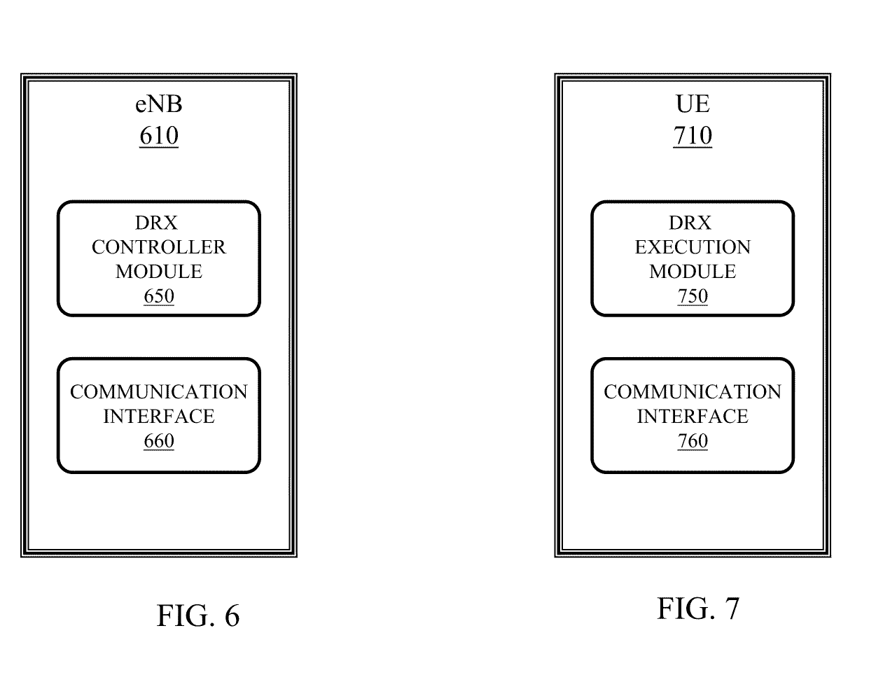

FIG. 6 is a high-level block diagram of an exemplary eNodeB 610, according to an embodiment of the invention. In general, the eNodeB 610 includes a DRX controller module 650 adapted to determine the set of DRX parameters and the current DRX parameter or the DRX parameter to be applied per UE. Furthermore, the DRX controller module 650 is adapted to signal DRX instructions via in-band signaling and RRC signaling. The DRX controller module 650 may also be adapted to perform the eNodeB-side processes, described herein. The eNodeB 610 may also include a radio communication interface 660 adapted to enable the eNodeB 610 to communicate with the UEs it manages. Other modules may also be added but not shown. The DRX controller module 650 and the communication interface 660 may interface with each other.

FIG. 7 is a high-level block diagram of an exemplary UE 710, according to an embodiment of the invention. In general, the UE 710 includes a DRX execution module 750 adapted to receive in-band signaling and RRC signaling, and accordingly follow the instructions as signaled via these signals. The DRX execution module 750 may also be adapted to perform the UE-side processes, described herein. The UE 710 may also include a radio communication interface 760 adapted to enable the UE 710 to communicate with an eNodeB. Other modules may also be added but not shown. The DRX execution module 750 and the communication interface 760 may interface with each other. The modules described in FIGS. 6 and 7 may be embodied in software, hardware, or both, i.e., firmware. Furthermore, they may be combined or further subdivided and yet still be in the scope of the present invention.

Although the embodiments of the present invention discussed herein are exemplified using E-UTRA, E-UTRAN, and 3GPP LTE, the features of the present invention may be applied to other systems and networks that may require fast adjustment of DRX parameters to save power consumption and/or provide good throughput performance. For example, the embodiments of the present invention may also be applied on other radio systems, including, but not limited to WLAN, IEEE 802.16, IEEE 802.20 networks. A UE corresponds to a mobile terminal, and eNodeB corresponds to a base station there.

Embodiments of the present invention may be used in conjunction with networks, systems, and devices that may employ DRX parameters. Although this invention has been disclosed in the context of certain embodiments and examples, it will be understood by those of ordinary skill in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of ordinary skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

1. A method of discontinuous reception (DRX) management by an eNodeB, the method comprising the steps of:
receiving via a Layer 3 signaling, by a user equipment (UE), a set of one or more DRX parameters;
determining by said eNodeB a current DRX indicator for said UE;
transmitting by said eNodeB said current DRX indicator via a Layer 2 protocol data unit;
receiving by said UE said Layer 2 protocol data unit (PDU);
associating said current DRX indicator to a DRX parameter from said set of one or more DRX parameters; and
applying by said UE said associated DRX parameter for discontinuous reception.

2. The method of claim 1, wherein said set of DRX parameters is related to DRX periods.

3. The method of claim 1, said Layer 3 signaling is via a radio resource control (RRC) protocol stack conforming to the Evolved Universal Terrestrial Radio Access (E-UTRA) and Evolved Universal Terrestrial Radio Access Network (E-UTRAN) specification.

4. The method of claim 1 wherein said current DRX indicator is represented by the information which indicate to said UE at least one of the following:
apply continuous reception;
apply the next longer DRX period;
apply the next shorter DRX period; and
apply the DRX period received via a Layer 3 signaling.

5. The method of claim 1 wherein said Layer 2 PDU is at least one of the following: a radio link control (RLC) PDU, and a Packet Data Convergence Protocol (PDCP) PDU.

6. The method of claim 1, wherein said Layer 2 PDU is a Medium Access Control (MAC) PDU.

7. The method of claim 2, wherein said current DRX indicator indicates applying the next longer DRX period or the next shorter DRX period, where the shortest DRX period means continuous reception.

8. The method of claim 2, wherein said current indicator indicates applying the DRX period received via a Layer 3 signaling.

9. The method of claim 1, wherein said current DRX indicator is stored in a header section of said Layer 2 PDU.

10. The method of claim 1, wherein said current DRX indicator is stored in a payload section of said Layer 2 PDU.

11. The method of claim 1, wherein said step of receiving by said UE of said Layer 2 PDU is via a radio network.

12. A system comprising:
an eNode B comprising:
a DRX controller module adapted to:
determine a set of one or more discontinuous reception (DRX) parameters;
transmit said set of DRX parameters to a user equipment (UE) via Layer 3 signaling;
determine a current DRX indicator for said UE; and
transmit said current DRX indicator to said UE via a Layer 2 protocol data unit (PDU); and
a communication interface module adapted to:
enable communication between said UE and said eNodeB; and
said UE comprising:
a DRX execution module adapted to:
receive said set of discontinuous reception (DRX) parameters transmitted by said eNodeB;
receive said current DRX indicator via said Layer 2 PDU;
associate said current DRX indicator to a DRX parameter from said set of DRX parameters; and
apply said associated DRX parameter for discontinuous reception; and
a communication interface module adapted to:
enable communication between said UE and said eNodeB.

13. The system of claim 12 wherein said communication interface of said eNodeB and said communication interface of said UE are both radio communication interfaces.

14. The system of claim 12, wherein said current DRX indicator indicates at least one of the following:
apply continuous reception;
apply the next longer DRX period;
apply the next shorter DRX period; and
apply the DRX period received via a Layer 3 signaling.

15. The system of claim 12, wherein said Layer 2 PDU is a Medium Access Control (MAC) PDU.

16. The system of claim 12, wherein said set of DRX parameters is related to DRX periods.

17. The system of claim 16, wherein said current indicator indicates applying the next longer DRX period or the next shorter DRX period, where the shortest DRX period means continuous reception.

18. The system of claim 16, where in said current DRX indicator indicates applying the DRX period received via a Layer 3 signaling.

19. The system of claim 12, wherein said current DRX indicator is stored in a header section of said Layer 2 PDU.

20. The system of claim 12, wherein said current DRX indicator is stored in a payload section of said Layer 2 PDU.

21. The system of claim 12, further comprising:
a radio network conforming to an Evolved Universal Terrestrial Radio Access Network (E-UTRAN) specification with which said eNodeB and said UE communicate with each other.

22. A user equipment device adapted to communicate with an eNodeB, said device comprising:
a DRX execution module adapted to:
receive a set of discontinuous reception (DRX) parameters transmitted by said eNodeB via Layer 3 signaling;
receive a current DRX indicator via said Layer 2 PDU;
associate said current DRX indicator to a DRX parameter from said set of DRX parameters; and
apply said associated DRX parameter for discontinuous reception; and
a communication interface module adapted to:
enable communication between said device and said eNodeB.

23. The device of claim 22, wherein said set of DRX parameters is transmitted via a signaling between Radio Resource Control (RRC) Layer, and said Layer 2 PDU is a Medium Access Control (MAC) PDU.

24. The device of claim 22, wherein said set of DRX parameters is related to DRX periods.

25. The device of claim 24, wherein said DRX execution module associates said current indicator to either the next longer or the next shorter DRX period, where the shortest DRX period means continuous reception, and applies said associated DRX period for discontinuous reception.

26. The device of claim 24, wherein said DRX execution module associates said current indicator to said DRX period received via a Layer 3 signaling, and applies said associated DRX period for discontinuous reception.

27. A base station of Radio Access Network comprising:
a discontinuous reception (DRX) controller module adapted to:
transmit, via a Layer 3 signaling, to a user equipment (UE) a set of one or more DRX parameters;
determine a current DRX indicator for said UE;
transmit said current DRX indicator via a Layer 2 protocol data unit;
a communication interface module adapted to:
enable communication between said UE and the said base station.

28. The device of claim 27, wherein said set of DRX parameters is transmitted via a signaling between Radio Resource Control (RRC) Layer, and said Layer 2 PDU is a Medium Access Control (MAC) PDU.

29. The device of claim 27, wherein said set of DRX parameters is related to DRX periods.

30. The device of claim 29, wherein said DRX controller module determines said current DRX indicator which indicates association of said DRX indicator with said DRX period, and to apply said DRX period for discontinuous reception for said UE.
